(19) United States
(12) Patent Application Publication
(10) Pub. No.: US 2025/0370260 A1
(43) Pub. Date: Dec. 4, 2025

(54) DISPLAY INTEGRATION

(71) Applicant: VueReal Inc., Waterloo (CA)

(72) Inventors: Gholamreza CHAJI, Kitchener (CA); John CRONIN, Jericho, VT (US)

(73) Assignee: VueReal Inc., Waterloo, ON (CA)

(21) Appl. No.: 18/873,823

(22) PCT Filed: Jun. 30, 2023
(86) PCT No.: PCT/US2023/026768

§ 371 Date: Dec. 11, 2024

Related U.S. Application Data
(60) Provisional application No. 63/357,842, filed on Jul. 1, 2022.

(51) Int. Cl. G02B 27/01

(52) U.S. Cl. CPC G02B 27/0172; G02B 2027/0112; G02B 2027/0118; G02B 2027/0178

(57) ABSTRACT

The present invention discloses a method and an apparatus to integrate display subarrays into glass lenses with the display subarray comprising an emissive array and a reflective optical component that redirects lights from the emissive array. Further, a shield also reflects ambient light. The present invention also discloses an augmented reality system with integrated display subarrays.

### CROSS-REFERENCE TO RELATED APPLICATIONS

This application claims the benefit of, and priority to, U.S. Provisional Patent Application No. 63/357,842 filed Jul. 1, 2022, which is hereby incorporated by reference herein in its entirety.

### BACKGROUND AND FIELD OF THE INVENTION

The present invention relates to full-color AR displays. Augmented reality (AR) uses technology to combine a simulated environment with a real environment. AR relies on optics to create a simulated environment that annotates or enhances the real environment so that the user can experience them as one environment. The hardware for augmented reality typically includes a computer capable of real-time simulation that synchronizes and maps the simulated to the real environment using a visual output display.

### SUMMARY

The present invention relates to a method to integrate display subarrays into glass lenses, the method comprising having display subarrays and an optical system, having glasses with at least one lens, having the display subarrays comprising an emissive array, having an optical system on top of the emissive array delivering lights to a viewer's eye and having a shield layer between the emissive array and the glass lens.

The present invention also relates to an apparatus to integrate display subarrays into glass lenses, comprising, a display subarrays and an optical system, glasses with at least one lens, the display subarrays comprising an emissive array; an optical system disposed on top of the emissive array delivering lights to a viewer eye and a shield layer between the emissive array and the glass lens.

The present invention also relates to an augmented reality system comprising of glasses lens, an array of color conversion pixel developed on the glasses lens, an array of shield layer preventing the ambient light to reach the color conversion pixel, an array of optics directing the light generated by color conversion pixels to the viewer eye and a display generating high energy light source and an optics to direct the lights to the array of color conversion pixels.

### BRIEF DESCRIPTION OF DRAWINGS

The preceding and other advantages of the disclosure will become apparent upon reading the following detailed description and upon reference to the drawings.

FIG. 1A shows glasses with one or two lenses.

FIG. 1B shows a close-up view of the subarrays integrated into the lens.

FIG. 1C shows another related embodiment where the sub-array includes an emissive layer 106 and reflective optics.

FIG. 2A shows an embodiment where an array of color conversions is integrated into the glass lens.

FIG. 2B shows an example of a glass lens as an optical system.

FIG. 3A shows an embodiment where the color conversion array is integrated on the top surface of a waveguide structure.

FIG. 3B shows a cross-section of the waveguide with a color conversion array layer.

FIG. 3C shows an exemplary implementation of color conversion array and outcoupling layers.

FIG. 4A shows a structure with a shield layer preventing the lights from affecting the color conversion pixel 404 from one side.

FIG. 4B is a similar structure to FIG. 4A, where the light from the display passes to the shield layer or color conversion pixel from the color conversion surface or the area around the color conversion pixel.

FIG. 4C shows a structure where different color conversion pixels and shield pixels (R, G, B) each create different colors.

FIG. 5 shows a system structure using display and color conversion pixel arrays (R G B) on a glass lens.

### DETAIL DESCRIPTION

The following description describes a method and an apparatus to integrate display subarrays into a glass lens system. Further it also describes an augmented reality display system related to the method and apparatus.

Creating a full-color AR system requires high brightness and high-resolution displays and optics to overlay the image in the real world.

In one embodiment, the display is integrated into the glasses in front of the user's eyes. The display consists of an array of smaller individual subarrays.

In one related embodiment, the subarrays may include the driving backplane, emissive devices and optics. In one related embodiment, the backplane, emissive, and optics devices are integrated first and then transferred into the glass lens. In one related embodiment, the traces in the glass lens connect the subarrays to the driver at the edge of the lens. The driver provides data to subarrays and communicates with video or image sources/processor or timing controller for the display.

In one embodiment, a shield behind the pixel segments allows the light only to go toward the user's eye.

In one related embodiment, the optics device is a lens or array of lenses integrated on top of the emissive layer. In another related embodiment, the optics device is a mirror facing the user's eye. Here, the pixel subarray is projecting light into the mirror, and the mirror redirects the image to the user's eye.

The challenge with such structures is connecting the subarrays and the drivers.

In another related embodiment, an external display provides lights that excite the color conversion array integrated into the glass lens. In this embodiment, an array of different color conversion pixels are patterned on the glass lens. A display including an array of pixels generating high-energy photons is used to excite the array of color conversion pixels.

A shield layer prevents the color conversion from getting excited by the ambient lights. The optical system can be a mirror or lens or a combination of different optics structures. The display source can be integrated into a glass handle or a glass frame. An optical system may direct the lights from the display to the color conversion layer. The color conversions are patterned in smaller areas. The display and delivery optical system can get calibrated to align and focus the display lights on the proper color conversion segments.

In another related case, a set of pixels in the display turns ON and the activated color conversion areas are mapped to the pixels. The process can continue until the displays' pixels are mapped to the color conversion areas. The video data is mapped to the display pixels during the display operation based on the color conversion mapping.

In another related embodiment, the display resolution can be less than the resolution of the color conversion array.

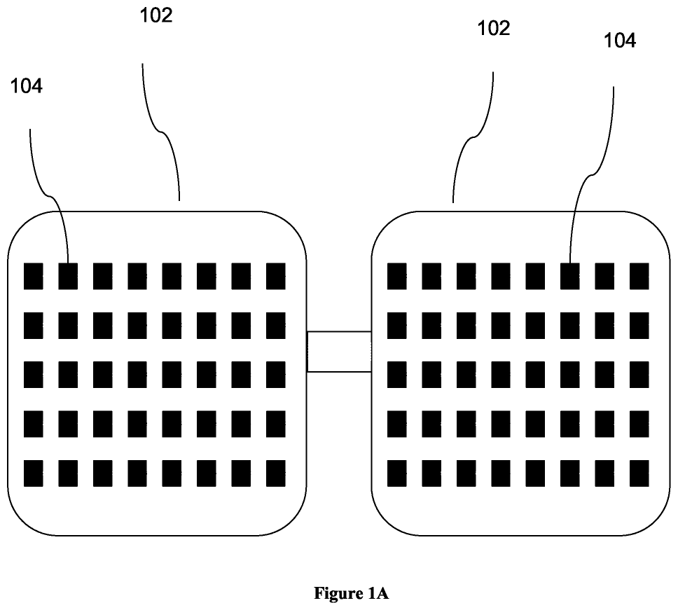

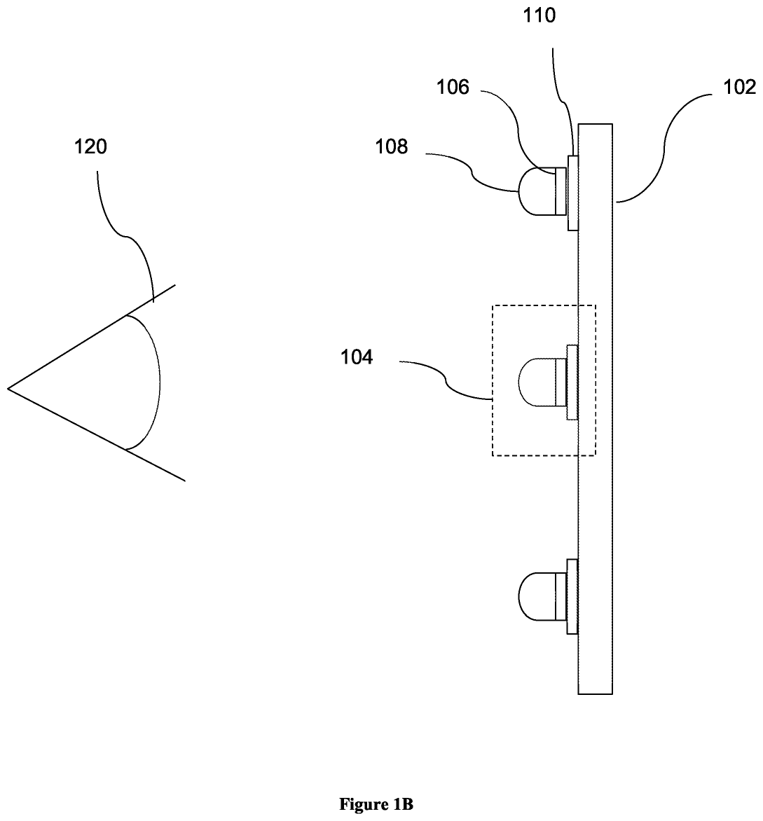

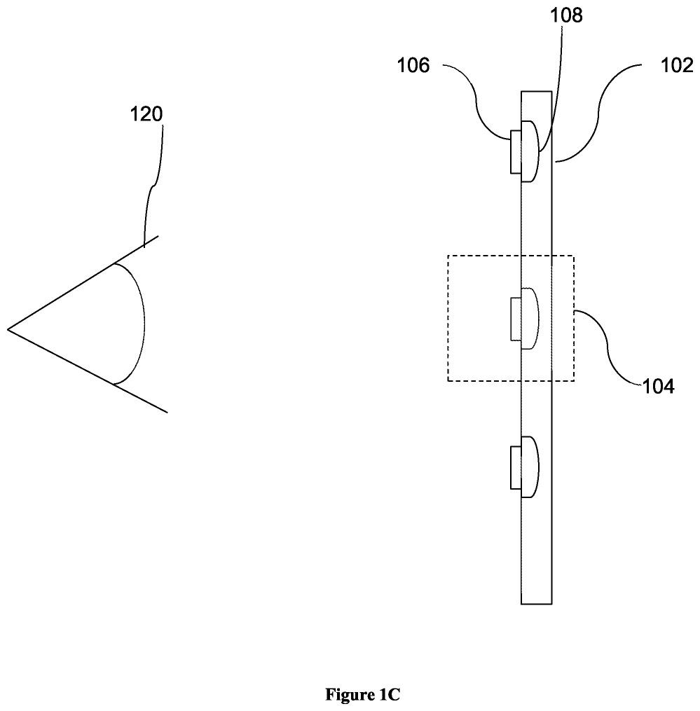

FIG. 1A shows glasses with one or two lenses 102. The glasses may be single-Lens Glasses. The glasses may be monocular glasses: These glasses have a single lens designed for one eye only. They are typically used to correct vision in one eye while leaving the other eye unobstructed. The glasses may be monovision Glasses: These glasses are prescribed for individuals with presbyopia, a condition where the ability to focus on near objects decreases with age. One lens is designed for distance vision, while the other lens is intended for near vision.

The glasses may be dual-lens Glasses: The glasses may be bifocal glasses: Bifocals have two distinct optical powers in a single lens. The upper portion of the lens corrects distance vision, while the lower portion helps with near vision. They are often prescribed for individuals with presbyopia. The glasses may be trifocal glasses: Trifocals have three distinct optical powers in a single lens. The segments are typically arranged with distance vision on top, intermediate vision in the middle, and near vision at the bottom. Trifocals are also used to address presbyopia. The glasses may be progressive/no-line bifocal glasses: Progressive lenses offer a smooth transition of optical powers, without the visible dividing lines found in bifocals or trifocals. They provide a gradual change in prescription from the top to the bottom of the lens, allowing for clear vision at multiple distances. The glasses may be specialty glasses, such as safety glasses: These glasses feature impact-resistant lenses and are designed to protect the eyes during various activities, such as sports, construction work, or laboratory experiments. The glasses may be sunglasses. Sunglasses are designed to protect the eyes from harmful ultraviolet (UV) rays and intense light. They come in various styles and lens tints to provide different levels of protection and visual comfort. The glasses may be computer glasses: These glasses are specifically designed to reduce eye strain and discomfort caused by prolonged computer or digital device use. They usually feature lenses with an anti-reflective coating to minimize glare.

There is an array of display subarrays 104 integrated into the lenses 102. The subarrays 104 comprises optical system and emissive arrays. Emissive arrays may be Organic Light-Emitting Diode (OLED) Displays. OLED displays consist of thin films of organic compounds that emit light when an electric current is applied. These displays offer high contrast ratios, wide viewing angles, and vibrant colors. OLED technology is commonly used in smartphones, televisions, and wearable devices. Emissive arrays may be Active Matrix Organic Light-Emitting Diode (AMOLED) Displays. AMOLED displays are a type of OLED display that use a thin-film transistor (TFT) array to control the current flowing through each pixel. This allows for faster pixel response times and improved image quality. AMOLED displays are widely used in smartphones and high-end televisions. Emissive arrays may be MicroLED Displays. MicroLED displays utilize an array of microscopic light-emitting diodes (LEDs) to create images. Each pixel in a microLED display is made up of a tiny individual LED. MicroLED technology offers high brightness, wide color gamut, and excellent contrast ratios. It has the potential to provide superior image quality and is being explored for various applications, including large-scale displays and virtual reality headsets. Emissive arrays may be Quantum Dot Displays. Quantum dot displays use semiconductor nanocrystals called quantum dots to enhance the color performance of LCD (liquid crystal display) panels. Quantum dots emit light of specific colors when excited by a light source. When combined with an LED backlight, quantum dot displays can achieve a wider color gamut and improved color accuracy compared to traditional LCD displays. Emissive arrays may be electroluminescent Displays. Electroluminescent displays use a thin phosphorescent material that emits light when an electric current is applied. They can be flexible, allowing for the creation of curved or rollable displays. Electroluminescent displays are commonly found in applications such as smartwatches, automotive displays, and small handheld devices. Emissive arrays may be Laser-Induced Displays. Laser-induced displays utilize lasers to excite specific materials that then emit light. This technology is still in the early stages of development and has the potential to offer high brightness, energy efficiency, and color reproduction.

FIG. 1B shows a close-up view of the subarrays 104 integrated into the lens 102. The subarray 104 may comprise an emissive array 106. There can be an optical system 108 on top of the emissive array 106 to deliver the lights to the viewer's eyes 120. The optical system 108 can be made of lenses or a combination of different optical components. An optical system can incorporate a variety of lenses or a combination of different optical components to achieve specific functionalities. Here are some examples of lenses and optical components commonly used in optical systems. For instance, the lens could be Convex Lens: A convex lens bulges outward in the middle and is thicker at the center than at the edges. It converges incoming light rays to a focal point, resulting in magnification and focusing. Convex lenses are widely used in applications such as cameras, telescopes, magnifying glasses, and eyeglasses. In another examples the lens could be Concave Lens: A concave lens is thinner at the center and curves inward at the edges. It diverges incoming light rays and spreads them out. Concave lenses are often used to correct nearsightedness (myopia) and are also utilized in optical systems like microscope eyepieces and cameras. In another example the lens could be an Achromatic Lens: An achromatic lens is composed of multiple lens elements with different types of glass to minimize chromatic aberration. Chromatic aberration causes color fringing and distortion in images. Achromatic lenses are used in cameras, telescopes, microscopes, and other systems where color correction is important. In another example the lens could be Aspheric Lens: Aspheric lenses have a non-spherical surface, which allows for better correction of spherical aberration and other aberrations compared to traditional spherical lenses. Aspheric lenses are utilized in applications like high-quality camera lenses, projectors, and laser collimation systems. In another example the lens could be. In another example the lens could be Cylindrical Lens. Cylindrical lenses have different curvatures along one axis, resulting in different focal lengths in different planes. They are used to focus or diverge light in a specific direction, correct astigmatism, or create anamorphic effects. Cylindrical lenses find applications in laser optics, barcode scanners, and ophthalmic lenses. In another example the lens could be prism: A prism is a transparent optical element with flat polished surfaces that can refract, reflect, and disperse light. Prisms are used in optical systems for light redirection, beam steering, dispersion, and image rotation. They are commonly found in binoculars, cameras, spectrometers, and optical instruments. In another example the lens could be a Beam Splitter: A beam splitter is an optical device that divides a light beam into two or more separate beams. It can transmit a portion of light while reflecting another portion. Beam splitters are essential in applications like cameras, interferometers, optical microscopy, and laser systems. In another example the lens could be Polarizing Filter. A polarizing filter is an optical component that selectively transmits light waves vibrating in a particular direction. It is used to control or eliminate polarized light, reduce glare, or enhance contrast. Polarizing filters are commonly used in photography, LCD displays, and optical instruments.

There can be a shield layer 110 between the emissive layer 106 and the glass lens 102.

FIG. 1C shows another related embodiment where the sub array 104 includes an emissive layer 106 and reflective optical system 108. The reflective material may be, for instance, Aluminum: Aluminum is a widely used reflective material due to its high reflectivity across the visible spectrum. It is commonly applied as a thin metallic coating on glass or other substrates to create reflective surfaces. The reflective material may also be silver: Silver has excellent reflectivity, especially in the visible and infrared regions of the electromagnetic spectrum. It is commonly used in high-quality reflective coatings for optical applications. The reflective material may also be gold. Gold is known for its high reflectivity, particularly in the infrared range. It is used in specialized reflective coatings for applications such as infrared optics, thermal imaging, and spectroscopy. The reflective material may also be enhanced aluminum: Enhanced aluminum coatings consist of multiple layers of dielectric materials and aluminum. This coating design improves the reflectivity over a broader wavelength range compared to a simple aluminum coating. The reflective material may also be dielectric mirrors: Dielectric mirrors are multilayer coatings composed of alternating high-and low-refractive-index materials. They are designed to reflect specific wavelengths while transmitting others, allowing for precise control of the reflected light spectrum. The reflective material may also be enhanced silver. Enhanced silver coatings are multi-layered coatings that improve the reflectivity of silver by protecting it from oxidation and enhancing its durability. They provide high reflectivity over a wide spectral range. The reflective material may also be enhanced gold, Enhanced gold coatings employ dielectric layers to enhance the reflectivity of gold and extend its spectral performance. These coatings are used in specialized applications requiring high reflectivity in the infrared range. The reflective material may also be Aluminum-Magnesium Fluoride (Al/MgF2): Al/MgF2 coatings combine aluminum with a layer of magnesium fluoride (MgF2). This combination enhances the durability and reflectivity of the aluminum coating while also reducing its susceptibility to oxidation. The reflective material may also be protected silver: Protected silver coatings have a dielectric layer on top of the silver layer, providing increased durability and protection against tarnishing. They offer high reflectivity across a broad wavelength range, making them suitable for various applications. The reflective material may also be rhodium: Rhodium is occasionally used as a reflective material, especially in specialized optics where high reflectivity and durability are required. It has good reflectivity in the visible and infrared regions.

The reflective optical system 108 redirects the lights from the emissive layer (facing the optics 108) to the user eye 120. Here, the reflective optical system 108 can also shield the lights from going away from the user's eye to the other side of the lens 102 opposite to the user's eye 120.

In one embodiment related to FIG. 1 (A B C), the subarrays are fabricated and then laminated to the glass lens 102. There can be another layer or lens on top of the subarrays 104. Integration between the subarrays and the glass lens may also be accomplished by Microfabrication Techniques: Microfabrication techniques, such as photolithography, etching, and deposition, can be used to fabricate subarrays directly on the surface of a glass lens. This involves patterning and etching thin film materials, such as metals or semiconductors, onto the lens to create the desired subarray structure. Integration between the subarrays and the glass lens may also be accomplished by Thin-Film Deposition and Bonding. Subarrays can be fabricated separately on a substrate using thin-film deposition techniques, such as sputtering or evaporation. Once the subarray is complete, it can be bonded to the surface of a glass lens using adhesives, optical bonding techniques, or even direct fusion bonding if compatible materials are used. Integration between the subarrays and the glass lens may also be accomplished by Masking and Doping Techniques. By using masking techniques, such as photolithography, specific regions of a glass lens can be masked and subjected to doping processes. Doping introduces different optical properties, such as refractive index variations or light-absorbing characteristics, to create subarrays within the lens. Integration between the subarrays and the glass lens may also be accomplished by Laser Ablation or Micromachining: Laser ablation or micromachining techniques can be employed to selectively remove or modify regions of the glass lens, creating subarrays. High-precision laser systems can be used to etch patterns or create surface structures directly onto the lens to achieve the desired subarray configuration. Integration between the subarrays and the glass lens may also be accomplished by Hybrid Integration. In some cases, subarrays can be fabricated separately using alternative materials and technologies, such as semiconductors or polymers, and then integrated with the glass lens. This involves bonding the prefabricated subarray components to the lens using adhesives, optical bonding techniques, or mechanical fixtures.

In one embodiment related to FIG. 1 (A, B, C), the emissive layer 106 can be microLED or OLED, or other types of emissive devices. It can have one or more than one pixel or sub-pixels. The optical system 108 can be configurable through voltage application. In one related case, the optical system can be meta surfaces or liquid crystal-based optics. Metasurfaces and liquid crystal-based optics offer exciting possibilities for optical systems due to their unique properties and capabilities. Here are some additional examples of how these technologies can be used. Metasurfaces can be used as Wavefront Manipulation: Metasurfaces can be designed to manipulate the phase, amplitude, and polarization of light waves, enabling precise control over the propagation direction and focusing properties. This can be used for beam steering, aberration correction, and shaping complex wavefronts. Metasurfaces can be used as Wavefront Polarization Control: Metasurfaces can selectively control the polarization state of light, allowing for polarization-sensitive applications such as polarimetry, polarization imaging, and polarization beam splitters. Metasurfaces can be used as Holography: Metasurfaces can be used to create flat, ultrathin holographic elements for applications like 3D displays, holographic imaging, and data storage. Metasurfaces can be used as Optical Filters. Metasurfaces can act as ultrathin, customizable optical filters, selectively transmitting or reflecting light based on the design parameters of the metasurface. This can be utilized for spectral filtering, color enhancement, or wavelength-specific light manipulation. Liquid Crystal-Based Optics may be Electrically Tunable Lenses. Liquid crystal lenses can be electronically controlled to change their focal length, allowing for dynamic focus adjustment without the need for mechanical movements. These lenses find applications in autofocus systems, adjustable optical devices, and adaptive optics. Liquid Crystal-Based Optics may be Spatial Light Modulators (SLMs). Liquid crystal-based SLMs can modulate the phase or amplitude of light with high spatial resolution. They are used in applications such as holography, beam shaping, optical trapping, and optical information processing. Liquid Crystal-Based Optics may be Switchable Optical Components. Liquid crystals can be used to create switchable optical components such as polarization switches, optical shutters, variable attenuators, and tunable filters. These components offer fast response times and can be controlled electrically or optically. Liquid Crystal-Based Optics may be Optical Modulators. Liquid crystal-based modulators can modulate the intensity, polarization, or phase of light for applications such as optical communications, displays, and optical signal processing. Liquid Crystal-Based Optics may be Beam Steering. Liquid crystal-based devices can be used for beam steering and optical deflection by controlling the refractive index profile within the liquid crystal medium. This enables applications such as optical scanners, laser beam steering, and optical switching.

The shield layer 110 can be developed on the lens first, and the emissive layers can be transferred on top of the shield 110. In one case, the optical system is integrated after the emissive layer 106 is transferred. To transfer an emissive layer on top of a shield layer that has already been developed on a lens, one possible method is through a technique called layer transfer or layer transfer lithography. For instance, first develop the shield layer. The shield layer 110 is first developed on the lens substrate using appropriate lithography techniques. This involves depositing a suitable material and patterning it to create the desired shield layer structure. Next is to prepare the emissive layer. The emissive layer 106, which typically consists of organic compounds in the case of OLEDs, is prepared separately on a different substrate using deposition techniques such as thermal evaporation or organic vapor deposition. The emissive layer is designed to emit light when an electric current is applied. Next develop a transfer of the emissive layer. After the emissive layer has been prepared, it needs to be transferred onto the shield layer on the lens substrate. Layer transfer lithography techniques can be employed to achieve this. One common approach is called peel-off transfer. In this method, a temporary substrate, often made of a sacrificial material, is used as a carrier for the emissive layer. The emissive layer is deposited onto the temporary substrate, and then it is carefully peeled off, allowing it to be transferred onto the shield layer on the lens. The emissive layer adheres to the shield layer, forming a continuous layer. Another method is known as stamp transfer lithography. Here, a stamp or mold with the desired pattern of the emissive layer is prepared. The stamp is brought into contact with the emissive layer on the temporary substrate and then transferred onto the shield layer on the lens. The stamp is carefully removed, leaving behind the emissive layer patterned according to the shield layer structure. Finally, integration and further processing is done. Once the emissive layer has been transferred onto the shield layer, the integrated optical system can undergo additional processing steps. This may involve encapsulation to protect the emissive layer and other components, electrical connections to provide power to the emissive layer, and any necessary testing and quality control procedures.

In another related case, the optics 108 is transferred to the emissive layer first, and then the emissive layer and optical system are transferred to the lens together. In one case, to form a reflective optical component, a layer is formed. This layer can be on top of the lens 102 or a carrier substrate. The layer is deformed or etched to create the shape needed for the optics. Etching is accomplished for example, wet etching: Wet etching involves immersing the layer or substrate in a chemical solution that selectively reacts with and removes the material. Different etchants are used for specific materials. For example, Buffered Oxide Etchants (BOE) for silicon dioxide (SiO2). Another example is Hydrofluoric acid (HF) for certain glasses and silicon-based materials. Another example is Piranha solution (sulfuric acid and hydrogen peroxide) for organic polymers. Another example is using dry etching. Dry etching is for example, Reactive Ion Etching (RIE). RIE uses plasma generated from a mixture of reactive gases to etch the material. The plasma chemically reacts with the surface, and ions bombard the material, removing it. RIE is commonly used for semiconductor materials, metals, and dielectrics. Dry etching could also be Plasma Etching. Plasma etching involves using a high-energy plasma to etch the material. Different plasma chemistries can be employed depending on the material. Examples include oxygen plasma for organic materials and fluorine-based plasmas for silicon-based materials. Dry etching could also be Ion Beam Etching (IBE). IBE involves bombarding the material with ions accelerated in a vacuum chamber. The ions sputter away the material, creating the desired shape. IBE offers high precision and is suitable for materials such as metals, semiconductors, and dielectrics.

A reflective layer or layers are deposited and patterned. The shape can be filled with sacrificial or transparent materials. The emissive layer is then bonded to the layer on top of the sacrificial layer. The sacrificial layer can be removed. The emissive layer faces the reflective layer (or layers). If the structure is developed on a carrier substrate, the structure is then transferred to the glass lens 102.

In another related embodiment, the emissive layer is transferred to a carrier substrate, and a transparent film or sacrificial layer is formed on top of the emissive layer. The sacrificial layer is then patterned to form the shape of the reflective optics. After that, reflective layers are formed on top of the sacrificial layer. The surface can be planarized with a polymer or other coating layers. The coating can be transparent. The full structure is laminated to the glass lens. The carrier substrate can be removed. The sacrificial layer can be removed. There can be electrical traces connecting the emissive layers to the edge of the lens for connection to the driving system, where the video and power signals are passed to the emissive layers through the traces.

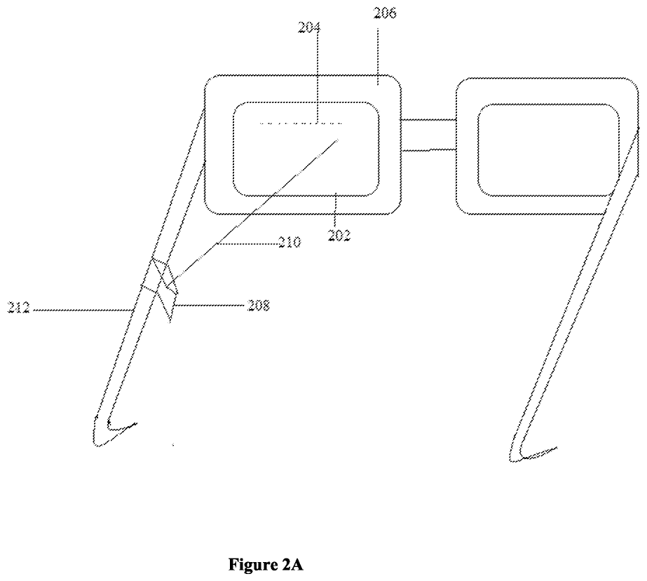

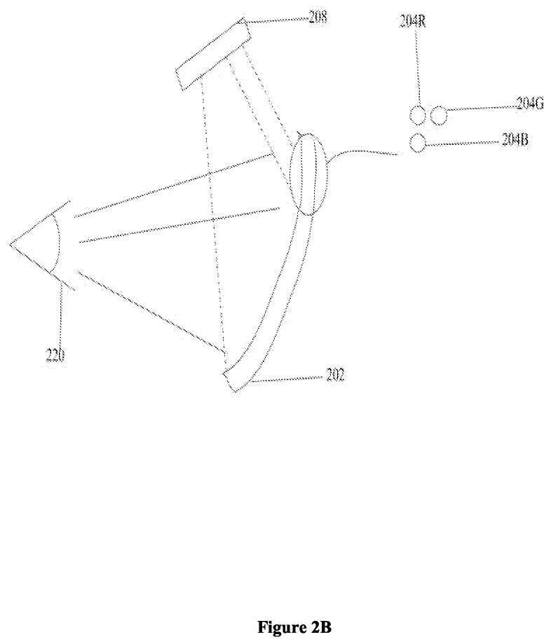

FIG. 2A shows an embodiment where an array of color conversion 204 is integrated into the glass lens 202. A display 208 integrated into frame 206 or glass handle 212 projects higher energy light is projected 210 into the lens 202. When it comes to displays integrated into eyeglass frames or handles that project higher energy light, there are a few possible examples. For example, a display could be Augmented Reality (AR) Display: AR displays integrated into eyeglass frames or handles can project higher energy light to overlay digital information onto the wearer's field of view. These displays typically utilize technologies such as waveguide optics or micro displays to project virtual images or information onto the lenses of the eyeglasses. For example, a display could be Heads-Up Display (HUD). HUDs integrated into eyeglass frames or handles project higher energy light to display information directly in the wearer's line of sight. This technology is often used in automotive applications, where essential information, such as speed, navigation, or warnings, is projected onto the windshield or a small transparent screen within the eyeglasses. For example a display could be Laser Projection Displays. Laser projection displays integrated into eyeglass frames or handles use laser light sources to project high-energy light onto a surface, creating a display. This technology allows for compact and portable displays with high brightness and color fidelity. Laser projection displays can be used for presentations, entertainment, or visualization purposes. For example, a display could be Virtual Reality (VR) Display. VR displays integrated into eyeglass frames or handles project higher energy light to create immersive virtual environments. These displays typically use high-resolution screens or micro displays combined with optical elements to provide a wide field of view and accurate tracking. VR displays can be used for gaming, training, simulation, or other immersive experiences. For example, a display could be Heads-Up Health Monitoring Display. In the context of smart eyeglasses, a heads-up health monitoring display integrated into the eyeglass frame or handle can project higher energy light to provide real-time health-related information to the wearer. This could include vital signs, fitness data, medication reminders, or other personalized health metrics. It's important to note that the term “higher energy light” can encompass various technologies, such as laser-based displays, high-intensity LED displays, or advanced projection systems. The specific implementation and technology choice would depend on the desired functionality and requirements of the display integrated into the eyeglass frames or handles.

The display 208 can include a light generation module and optics. The glass lens 202 can be formed as an optical system to reflect the light to the viewer's eye. In another related case, optics can be on top or under the color conversion array 204 to convey the light to the viewer. The color conversion layer can have different sub pixels creating different lights. Color conversion arrays are used to convert the color of light emitted by a light source to a desired output color. Color conversion arrays are for example, Quantum Dot Color Conversion. Quantum dots (QDs) are nanocrystals that can emit light of different colors depending on their size. A color conversion array using quantum dots can be incorporated into an optical system to convert the light emitted by a primary light source, such as blue LEDs, into a broad range of colors. This technology is commonly used in displays, lighting, and backlighting applications. Color conversion arrays can be for example Phosphor-based Color Conversion. Phosphors are materials that absorb light of one wavelength and emit light at a different, longer wavelength. In a color conversion array, phosphor layers can be applied over or under the optical components to convert the light emitted by the light source into the desired colors. Phosphor-based color conversion arrays are used in applications such as LED lighting, solid-state lighting, and fluorescent lamps. Dye-based Color Conversion can be dyes used in a color conversion array to absorb light of one color and emit light at a different color. By incorporating dye layers with different absorption and emission properties, a color conversion array can achieve a wide range of colors. Dye-based color conversion arrays find applications in display technologies, lighting, and color mixing systems. Color conversion arrays can be for example Color Filter Arrays (CFAs). Color filter arrays are used in image sensors, cameras, and displays to selectively filter incoming light into different colors. CFAs consist of an array of micro-scale color filters, typically red, green, and blue (RGB), that allow only specific colors to reach the sensor or display pixels. CFAs are widely used in digital cameras, smartphones, and displays to capture or reproduce color images. Color conversion arrays can be for example Quantum Rod Color Conversion. Quantum rods are elongated nanocrystals that exhibit color-tunable emission properties. By incorporating quantum rod layers in a color conversion array, light emitted by a light source can be efficiently converted into desired colors. Quantum rod color conversion arrays have potential applications in lighting, displays, and optoelectronic devices. These examples showcase different technologies used in color conversion arrays, each with its own advantages and applications. The specific choice of color conversion array depends on factors such as the desired color gamut, efficiency, stability, and cost considerations for a given optical system.

A shield under the color conversion layer can prevent the light from going in a direction opposite to the viewer's eye. There can be a protection layer or passivation layer protecting the color conversion 204 arrays. In one related case, a subset of pixels in the display 208 is turned on, and the image created by the color conversion is captured and mapped to the pixels of the display 208. The process can continue until most of the pixels in the display 208 or most of the pixels in the color conversion layer are mapped. In one related case, the display has a higher resolution than the color conversion array. Here, the extra remaining pixels in the display 208 can stay off. In another related embodiment, the color conversion array has more pixels than the display to facilitate the mapping. In another related embodiment, the display, the position of the display, the direction of the display, or the optics in the display 208 can be adjusted to adjust the display array mapping to the color conversion array 204. In another related embodiment, at least part of the area between the color conversion pixels is covered with material absorbing the higher energy light or redirecting the light from the viewer's eye (or face). Some other examples for sub pixels are PenTile Matrix Subpixel Arrangement. The PenTile matrix arrangement is a sub-pixel layout used in some displays, where each pixel is composed of a combination of differently colored sub-pixels. This arrangement typically includes two sub-pixels, one with green color and the other with a shared red and blue color. This arrangement can enhance resolution and reduce power consumption. Other examples of subpixels are RGBW Subpixel Arrangement. RGBW is a sub-pixel arrangement that includes red, green, blue, and white sub-pixels. The additional white sub-pixel can improve brightness and power efficiency by providing an extra source of light. This arrangement is commonly used in some LCD displays, especially in applications where high brightness is desired, such as outdoor signage. Other examples for sub pixels are Quattron Subpixel Arrangement. Quattron is a sub-pixel arrangement introduced by Sharp, which adds a yellow sub-pixel to the traditional red, green, and blue arrangement. The yellow sub-pixel is intended to enhance image brightness and color accuracy by enabling more precise control over color reproduction. Other examples for sub pixels are Micro-LED Array: Micro-LED arrays consist of an array of microscopic LEDs that emit red, green, and blue light. Each LED functions as a sub-pixel, enabling precise control over color reproduction and brightness. Micro-LED arrays offer high brightness, wide color gamut, and can be used in applications such as high-resolution displays and virtual reality headsets. Other examples for sub pixels are Patterned Color Conversion Layer: A patterned color conversion layer can be used to create sub-pixels with different color conversion properties. By applying a patterned layer with different color conversion materials, specific areas of the color conversion layer can selectively convert light to different colors. This enables the creation of sub-pixels with varying color properties within the color conversion array.

FIG. 2B shows an example of a glass lens 202 as an optical system. Here, the display 208 projects higher energy light into an array of color conversion array 204 (R, G, B) in the lens 202. The color conversion layer 204 (R, G, B) makes new colors and directs the lights to the viewer's eye 220. There can be reflectors in the lens 220 that reflect the converted lights to the viewer's eye 220. The reflector can also reflect the light generated by the display to the color conversion layer 204 (R, G, B). There can also be light collimator optics or other optics on the color conversion layer 204 (R, G, B) to culminate or redirect the light into the viewer's eye. The color conversion can have one or more than one sub-pixels. The lens is transparent or semi-transparent to allow the lights from the environment to meet the viewer's eye. The area between the color conversion pixels can be covered by layers that absorb or redirect the high-energy lights from the display.

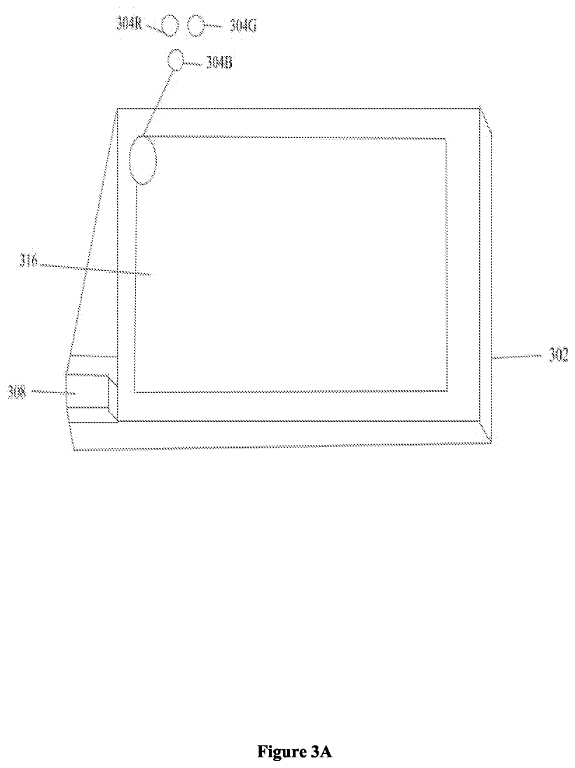

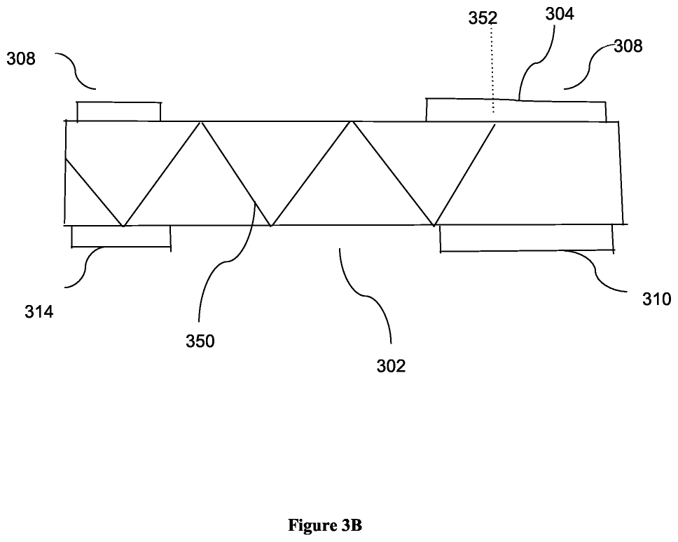

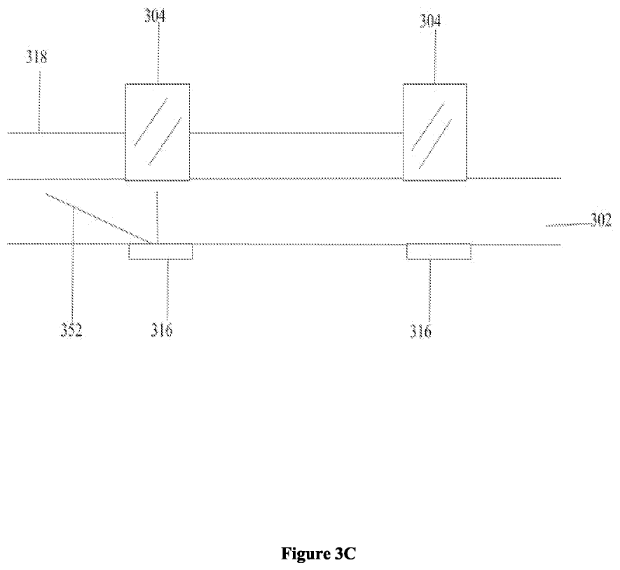

FIG. 3A shows an embodiment where the color conversion array is integrated on the top surface of a waveguide structure 302. Here, a display 308 generates high-energy photons, and the light is coupled to the waveguide 302. The light exits from the top surface 316 of the waveguide 302, where the color conversion array 304 (R, G, B) is developed. The color conversion pixels 304 (R, G, B) are developed in places where lights exist on the top surface 316 and form pixels. In another example, the embodiment could be for Near-Eye Displays. Near-eye displays, such as augmented reality (AR) or virtual reality (VR) headsets, can utilize waveguide structures integrated with color conversion arrays on the top surface. The waveguide directs the high-energy photons from the display to the color conversion array, which then converts the light into different colors for the user's viewing. This enables the visualization of virtual objects, information, or immersive content in the user's field of view. In another example, the embodiment could be for Smart Glasses or Wearable Displays. Smart glasses or wearable displays can feature a waveguide structure with an integrated color conversion array on the top surface. The high-energy photons generated by the display are guided through the waveguide, and the color conversion array on the top surface converts the light into different colors. This allows for the presentation of visual information, notifications, or augmented reality content to the wearer. In another example, the embodiment could be for Optical See-Through Display. Optical see-through displays, used in applications like augmented reality (AR) eyeglasses or helmet visors, can integrate a waveguide structure with a color conversion array on the top surface. The waveguide directs the high-energy photons to the color conversion array, which then converts the light into different colors for overlaying digital information or virtual objects onto the wearer's view of the real world. In another example, the embodiment could be for Head-Mounted Display (HMD). Head-mounted displays, including virtual reality (VR) or mixed reality (MR) devices, can employ a waveguide structure with an integrated color conversion array on the top surface. The high-energy photons from the display are directed to the waveguide, and the color conversion array converts the light into different colors for immersive visual experiences.

FIG. 3B shows a cross-section of the waveguide 302 with color conversion array layer 304. The display 308 can be on the top surface of the other surface of the waveguide 302. An input coupling surface 314 is formed on the opposite side of display 308. The light 350 goes through internal reflection and hits an out-coupling layer 310. The light exits from the opposite side or from the same side of the out-coupling layer. A color conversion array 304 is developed on the surface where the light exits the waveguide structure. An example of waveguide 302 could be a Planar Waveguide. A planar waveguide consists of a thin, flat waveguide core layer that guides light through total internal reflection. It is typically made of a high refractive index material, such as glass or polymer. Planar waveguides are commonly used in integrated optics, optical interconnects, and display technologies. Another example of waveguide 302 could be a Channel Waveguide. Channel waveguides confine light within a narrow channel or ridge structure. They are often created by etching or depositing high refractive index materials onto a substrate. Channel waveguides provide strong light confinement and are utilized in applications like integrated photonic circuits, optical sensors, and telecommunications. Another example of waveguide 302 could be a Strip Waveguide. Strip waveguides are similar to channel waveguides but have a wider guiding region. They consist of a strip-like core surrounded by lower refractive index cladding layers. Strip waveguides are suitable for multimode light propagation and are commonly used in optical communication systems and light wave circuits. Another example of waveguide 302 could be a Rib Waveguide. Rib waveguides are similar to strip waveguides but feature raised ridges on the core layer. These ridges provide additional lateral confinement of light, enabling higher guiding efficiency and better control of mode propagation. Rib waveguides are often used in photonic integrated circuits and optical sensors. Another example of waveguide 302 could be a Photonic Crystal Waveguide. Photonic crystal waveguides utilize periodic variations in refractive index to confine light within specific bandgaps. They are engineered structures with patterned regions that create a photonic bandgap, preventing light propagation in certain directions. Photonic crystal waveguides are used in photonic crystal devices, photonic crystals, and optical integrated circuits.

Another example of waveguide 302 could be a Polymer Waveguide. Polymer waveguides utilize organic polymers with tailored refractive index properties to guide light. They are flexible, low-cost, and compatible with fabrication processes like lithography. Polymer waveguides are commonly used in integrated optics, data communication, and optical interconnects.

FIG. 3C shows an exemplary implementation of color conversion array 304 and outcoupling 310 layers. Here the outcoupling layer has a pixelated structure 316 that reflects the light 352 out. A color conversion structure 304, as part of an array, is formed on the opposite side of the reflector structure. There can be a layer(s) 318 between the color conversion structures 304 that absorbed unwanted high-energy photons. The reflective layer can be on the surface of the waveguide or inside the waveguide structure. The waveguide 302 can be the glass lens, or it can be laminated to the glass lens.

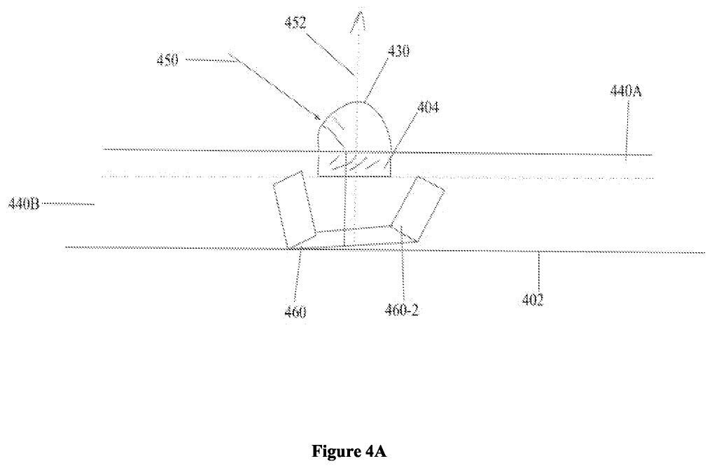

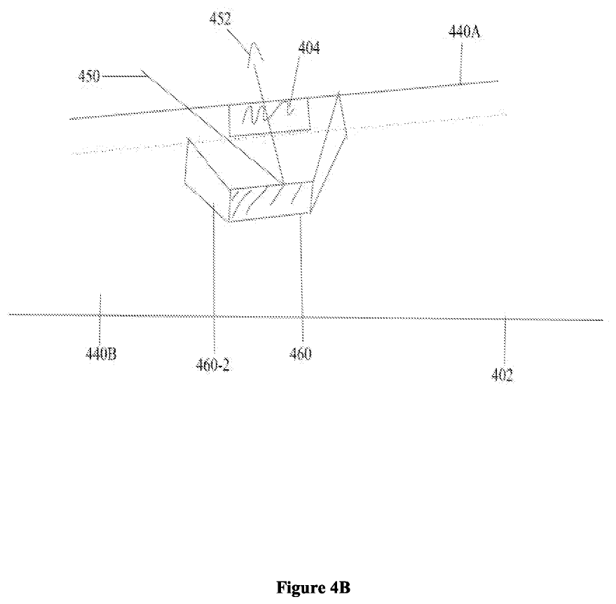

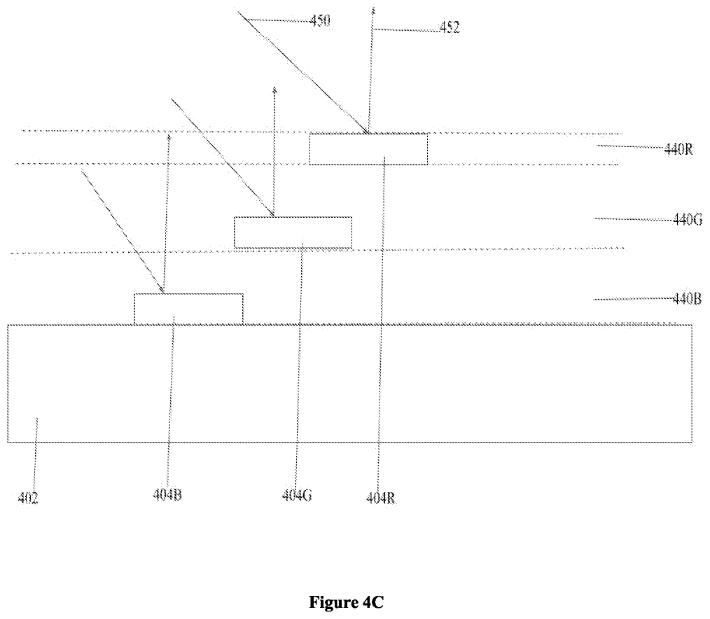

FIG. 4 (A, B, C) shows different methods of integrating color conversion layers into the glass lens. These methods can be used with any of the structures described here. In one related embodiment, the color conversion, shield or other layers are developed on or inside the glass lens. In another related embodiment, the color conversion arrays are formed on or inside a layer formed on the top of the glass lens. The process explained in FIG. 4 (A, B, C) can be used for either an approach of forming on/in glasses lens or forming in different layers.

FIG. 4A shows a structure where there is a shield layer 460 preventing the lights affecting the color conversion pixel 404 from one side. There can be a transparent film 440B covering the shield pixel 460. The transparent film 440B can be blocking some of the high energy photons. Color conversion pixel 404 is formed on top of the transparent film 440. An example of a transparent film is Polyethylene Terephthalate (PET.: PET is a commonly used transparent film material known for its excellent optical clarity and high mechanical strength. It has good resistance to moisture and chemicals, making it suitable for various applications, including protective films and displays. Another example of a transparent film is Polyethylene Naphthalate (PEN.: PEN is a transparent film material with similar properties to PET but with higher temperature resistance. It offers excellent dimensional stability and can withstand higher operating temperatures, making it suitable for applications with elevated heat requirements. Another example of a transparent film is Polycarbonate (PC). PC is a transparent film material known for its high impact resistance, optical clarity, and heat resistance. It is widely used in applications requiring both transparency and durability, such as protective films, displays, and optical components. Another example of a transparent film is Polyimide (PI). PI is a transparent film material that offers excellent thermal stability, chemical resistance, and mechanical strength. It can withstand high temperatures, making it suitable for applications in harsh environments, including flexible displays and integrated circuits. Another example of a transparent film is Cellulose Acetate (CA). CA is a transparent film material derived from cellulose. It offers good optical clarity, moisture resistance, and biodegradability. CA films are used in various applications, including protective films, packaging, and optical filters. Another example of a transparent film is Polysulfone (PSU). PSU is a transparent film material with good chemical resistance and high-temperature stability. It is known for its excellent dimensional stability and resistance to creep, making it suitable for applications where precise optical performance is required. Another example of a transparent film is Polyethylene Terephthalate Glycol (PETG). PETG is a transparent film material that combines the properties of PET and glycol-modified PET. It offers good impact resistance, clarity, and chemical resistance. PETG films are used in applications such as protective films, packaging, and displays.

In another related case, the color conversion pixel 404 is formed directly on top of the shield pixel 460. There can be another transparent film layer 440A covering at least part of the color conversion pixel sides. The transparent layer 440A can block some of the high energy photons. The first transparent layer 440B and second transparent layer 440A can be the same. The transparent film 440B can be etched or patterned to create an opening for the color conversion pixel 404. There can be a lens 430 on top of the color conversion pixel 404. The lens can direct the high energy light 450 from a display into the color conversion layer 404. The high energy light is converted into a desired color for the pixel. The desired light 452 is redirected back by the shield layer and lens toward the viewer eye. There can be an array of shield pixels and an array of color conversion pixels. There can be more than one type of color conversion pixel in the array creating more than one desired color. The total structure can be formed on a carrier substrate and then laminated on the glasses lens 402 or it can be developed directly on the glass lens. Transparent layers 440A and B can be part of the glass lens 402. The shield pixel layer can have sidewall 460 covering the side of the color conversion pixel. The shield pixel 460 and the sidewall 460-2 can be one structure. In one related embodiment, the shield 460 and sidewall 460-2 can form a concave mirror. The color conversion layer can have color filter structure as well to block some of the undesired lights either from the high energy photons or from the ambient environment. The lens 430 on top of the color conversion pixel 404 can be larger than the color conversion 404 pixel. The side wall structure 460 can be, for example, a tapered Sidewall. The sidewall structure can have a tapered shape, gradually sloping from the top surface of the shield pixel layer down to the color conversion pixel. This design can help to enhance light guiding and prevent unwanted reflections or scattering within the structure. Another example of a side wall structure 460 can be a Curved Sidewall. The sidewall structure can be curved, following a specific curvature or radius. This curvature can be designed to optimize light propagation and redirection, ensuring efficient light extraction from the color conversion pixel and reducing losses due to internal reflections. Another example of a side wall structure 460 can be a Faceted Sidewall. The sidewall structure can have a faceted shape with multiple flat or angled surfaces. Each facet can act as a mini-reflector, redirecting light toward the desired direction and preventing light leakage or crosstalk between neighboring pixels. Another example of a side wall structure 460 can be a Micro Lens Array. The sidewall structure can be composed of a micro lens array, where each sidewall surface features a small lens-like structure. This array can help to focus or collimate light within the structure, improving light extraction efficiency and directing light toward the desired viewing angle. Another example of a side wall structure 460 can be a Reflective Coating. The sidewall structure can be coated with a reflective material, such as a metal or dielectric coating. This coating acts as a mirror, reflecting light within the structure back towards the color conversion pixel, enhancing light extraction and minimizing losses due to absorption or scattering. Another example of a side wall structure 460 can be a Concave Mirror. As mentioned in the provided information, the shield pixel layer and sidewall structure can form a concave mirror shape. This structure can focus or converge light towards the color conversion pixel, improving light collection efficiency and enhancing the overall optical performance.

FIG. 4B is a similar structure as FIG. 4A. However, the light 450 from the display passes to the shield layer or color conversion pixel from the color conversion surface or the area around the color conversion pixel 404. There can be a lens on top of the color conversion pixel 404 as well. To create different colors, different color conversion pixels, including patterned color conversion layer, shield layer and optics, are formed either side by side or at different layers.

FIG. 4C shows a structure where different color conversion pixels and shield pixels 404 (R, G, B) each create different colors. In one related embodiment, each color conversion layer is formed on different layers 440R, 440G, 440B. These layers can be similar to the transparent layers in FIGS. 4A and 4B and the pixels 404 R, G, B can be formed similar to FIGS. 4A and 4B. 440R is a Red Color Conversion Layer. Layer 440R refers to the red color conversion layer in the structure. It is responsible for converting the incoming light into red color. The layer may contain materials or structures that selectively absorb or emit red wavelengths, allowing for the desired color conversion. 440G is a Green Color Conversion Layer. Layer 440G represents the green color conversion layer. It is designed to convert the incoming light into green color. The layer may incorporate materials or structures that selectively absorb or emit green wavelengths to achieve the desired color conversion. 440B Blue Color Conversion Layer. Layer 440B denotes the blue color conversion layer. Its purpose is to convert the incoming light into blue color. The layer may contain materials or structures that selectively absorb or emit blue wavelengths to achieve the desired color conversion. These layers, 440R, 440G, and 440B, are part of the color conversion structure in the optical system. Each layer is responsible for converting a specific range of wavelengths into the corresponding color (red, green, or blue) required for the desired color output. The exact composition and design of these layers would depend on the specific materials, technologies, and fabrication methods employed in the color conversion process.

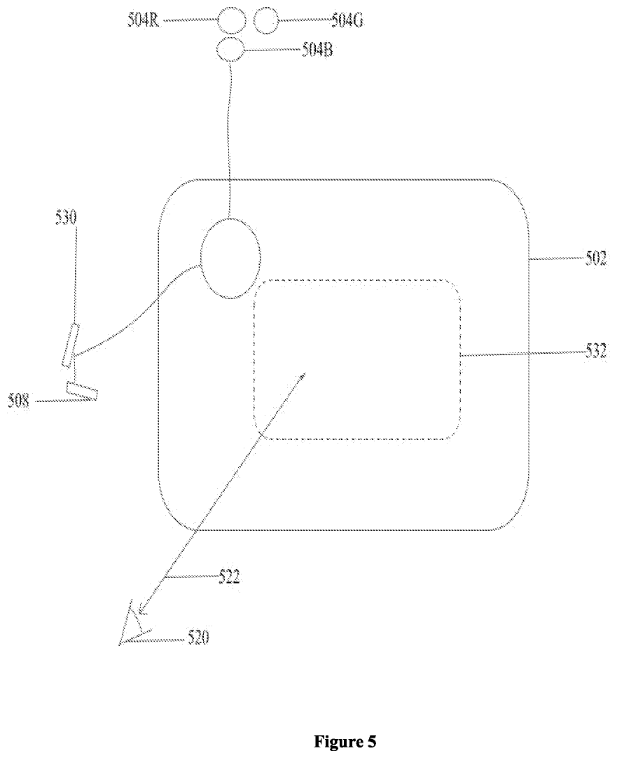

FIG. 5 shows a system structure using display 508 and color conversion pixel arrays 504 (R G B) on a glasses lens 502. The display 508 can be moved to areas 532 on the lens where the eye 520 is focused 522. The scanning happened by mirror 530. In the structure described in FIG. 5, where a display 508 and color conversion pixel arrays 504 (R, G, B) are integrated into a glass lens 502, scanning is achieved using a mirror 530. One example of scanning method is using Mechanical Scanning. Mechanical scanning involves physically moving the display 508 or mirror 530 to redirect the light path. This can be achieved using mechanisms such as motors, actuators, or mechanical linkages. The movement can be controlled to scan the display across different areas of the lens 502, aligning with the focused area 522 of the eye 520. Another example of scanning is Galvanometric Scanning. Galvanometric scanning utilizes galvanometer mirrors that can rapidly rotate or tilt to redirect the light beam. By controlling the movement of the galvanometer mirrors, the display 508 can be scanned across different regions of the lens 502. Galvanometric scanning offers high-speed scanning capabilities and precise control over the light path. Another example of scanning is MEMS Mirror Scanning. Microelectromechanical systems (MEMS) mirrors consist of tiny mirrors that can be electrostatically or electromagnetically actuated to change their position. These mirrors can be integrated into the system, allowing for controlled scanning of the display 508 across different areas of the lens 502. MEMS mirror scanning offers compact size and fast response times. Another example of scanning is Acousto-Optic Scanning. Acousto-optic scanning involves using acoustic waves to diffract light and steer the beam. By modulating the acoustic waves, the direction of the diffracted light can be controlled, enabling scanning of the display across the lens 502. Acousto-optic scanning offers fast scanning speeds and precise control. Another example of scanning is Optical Fiber Bundle Scanning. Optical fiber bundle scanning utilizes an array of optical fibers arranged in a bundle. By selectively illuminating different fibers, light can be redirected to specific areas of the lens 502. This scanning method allows for flexible and localized scanning of the display. These examples represent different scanning techniques that can be employed to move the display across different areas of the glass lens 502, aligning with the focused area 522 of the eye 520. The specific scanning method used would depend on factors such as scanning speed requirements, system complexity, and the desired size and resolution of the display.

While the present disclosure is susceptible to various modifications and alternative forms, specific embodiments or implementations have been shown by way of example in the drawings and will be described in detail herein. However, it should be understood that the disclosure is not intended to be limited to the particular forms disclosed. Rather, the disclosure is to cover all modifications, equivalents, and alternatives falling within the spirit and scope of the invention as defined by the appended claims.

1. An apparatus to integrate display subarrays into glass lenses, comprising;
a display subarrays and an optical system;
glasses with at least one lens;
the display subarrays comprising an emissive array;
an optical system disposed on top of the emissive array delivering lights to a viewer eye; and
a shield layer between the emissive array and the glass lens.

2. The apparatus of claim 1 wherein the optical system is made of lenses or a combination of different optical components.

3. The apparatus of claim 1 wherein the display subarray includes an emissive array and a reflective optical component wherein the reflective optical component redirects lights from the emissive array to the viewer's eye and shielding the lights from going away from the viewer's eye to an opposite side of the viewer's eye.

4. The apparatus of claim 1 wherein the display subarrays are fabricated and then laminated to the glass lens.

5. The apparatus of claim 1, wherein there is another layer or lens on top of the display subarrays.

6. The apparatus of claim 1 wherein the emissive array are microLED or OLED type devices and have one or more than one pixel or sub-pixels wherein further the optical system is configurable through a voltage application.

7. The apparatus of claim 6, wherein the optical system is metasurfaces or a liquid crystal-based optics and wherein the shield layer is developed on the glass lens first, and the emissive arrays are transferred on top of the shield.

8. The apparatus of claim 7, wherein the optical system is integrated after the emissive array is transferred.

9. The apparatus of claim 7, wherein the optical system is transferred to the emissive array first, and then the emissive array and optical system are transferred to the glass lens together.

10. The apparatus of claim 3, wherein a reflective layer (or layers) is formed on top of the lens or a carrier substrate wherein further the layer is deformed or etched to create a shape needed for the optical system.

11. The apparatus of claim 10, wherein the reflective layer is deposited and patterned, and the shape is filled with sacrificial or transparent materials wherein further the emissive layer is then bonded to a layer on top of a sacrificial layer.

12. The apparatus of claim 11 wherein the emissive array faces the reflective layer (or layers).

13. An augmented reality system comprising of:
glass lens;
an array of color conversion pixel developed on the glass lens;
an array of shield layer preventing the ambient light to reach the color conversion pixel;
an array of optics directing the light generated by color conversion pixels to the viewer eye; and
a display generating high energy light source and an optics to direct the lights to the array of color conversion pixels.

14. The system of claim 13, wherein the array of optics comprises lenses on top of one or two color conversion pixels.

15. The system of claim 13, wherein the array of optics redirecting the light from the display into the color conversion pixels and redirect the light of color conversion pixels into the viewer eye.

16. The system of claim 13, wherein the array of shield is reflective and reflects the lights of display back to the color conversion layer.

17. The system of claim 13, wherein the array of shield is opaque.

18. The system of claim 13, wherein a space between the color conversion layer is transparent.

19. The system of claim 14, wherein the space between the color conversion layer is covered by a material absorbing the high energy light.

20. A method to integrate display subarrays into glass lenses, the method comprising;
having a display subarrays and an optical system;
having glasses with at least one lens;
having the display subarrays comprising an emissive array;
having an optical system disposed on top of the emissive array delivering lights to a viewer eye; and
having a shield layer between the emissive array and the glass lens.

21. The method of claim 20 wherein the optical system is made of lenses or a combination of different optical components.

22. The method of claim 20 wherein the display subarray includes an emissive array and a reflective optical component wherein the reflective optical component redirects lights from the emissive array to the viewer's eye and shielding the lights from going away from the viewer's eye to an opposite side of the viewer's eye.

23. The method of claim 20 wherein the display subarrays are fabricated and then laminated to the glass lens.

24. The method of claim 20, wherein there is another layer or lens on top of the display subarrays.

25. The method of claim 20 wherein the emissive array are microLED or OLED type devices and have one or more than one pixel or sub-pixels wherein further the optical system is configurable through a voltage application.

26. The method of claim 25, wherein the optical system is metasurfaces or a liquid crystal-based optics and wherein the shield layer is developed on the glass lens first, and the emissive arrays are transferred on top of the shield.

27. The method of claim 26, wherein the optical system is integrated after the emissive array is transferred.

28. The method of claim 26, wherein the optical system is transferred to the emissive array first, and then the emissive array and optical system are transferred to the glass lens together.

29. The method of claim 22, wherein a reflective layer (or layers) is formed on top of the lens or a carrier substrate wherein further the layer is deformed or etched to create a shape needed for the optical system.

30. The method of claim 29, wherein the reflective layer is deposited and patterned, and the shape is filled with sacrificial or transparent materials wherein further the emissive layer is then bonded to a layer on top of a sacrificial layer.

31. The method of claim 30 wherein the sacrificial layer is removed, and the emissive array faces the reflective layer (or layers).
